(19) United States
(12) Patent Application Publication
(10) Pub. No.: US 2023/0013842 A1
(43) Pub. Date: Jan. 19, 2023

(54) HUMAN ASSISTED VIRTUAL AGENT SUPPORT

(71) Applicant: Hewlett-Packard Development Company, L.P., Spring, TX (US)

(72) Inventors: Shameed Sait M A, Bangalore (IN); Niranjan Damera Venkata, Chennai (IN); Kurian Chukirian Sebastian, Bangalore (IN)

(73) Assignee: Hewlett-Packard Development Company, L.P., Spring, TX (US)

(21) Appl. No.: 17/783,045

(22) PCT Filed: Dec. 20, 2019
(86) PCT No.: PCT/US2019/067853

§ 371 Date: Jun. 7, 2022

(51) Int. Cl. H04M 3/51; H04M 3/527; H04L 51/02; G06N 20/00

(52) U.S. Cl. CPC H04M 3/5175; H04M 3/527; H04L 51/02; G06N 20/00; H04M 2203/402

(57) ABSTRACT

Aspects of human assisted virtual agent support are discussed. A conversation between a user and a virtual agent may be monitored. A probability of the user abandoning the conversation may be predicted and a notification may be provided to a human agent to provide assistance in the conversation based on the probability.

### BACKGROUND

Companies utilize customer support centers to provide assistance to customers. At these centers, human support agents answer telephone calls or chat requests from customers for various inquiries, resolving issues, and the like. Currently, in customer support centers, a human support agent can handle one telephone call at a time or few, such as two or three, chat sessions concurrently.

### BRIEF DESCRIPTION OF DRAWINGS

The following detailed description references the figures, wherein:

FIG. 1 illustrates a system for providing human assisted virtual agent support, according to an example implementation of the present subject matter.

FIG. 2 illustrates a computing environment for human assisted virtual agent support, according to an example implementation of the present subject matter.

FIGS. 3(a)-3(c) illustrate example scenarios for human assisted virtual agent support, according to an example implementation of the present subject matter.

FIG. 4 illustrates an example user interface depicting human assisted virtual agent support, according to an example implementation of the present subject matter.

FIG. 5 illustrates a method of providing human assisted virtual agent support, according to an example implementation of the present subject matter; and

FIG. 6 illustrates a computing environment, implementing a non-transitory computer-readable medium for providing human assisted virtual agent support, according to an example implementation of the present subject matter.

### DETAILED DESCRIPTION

A customer support center is generally a location where multiple human support agents answer telephone calls or respond to text messages from users looking for support. During the conversations, the human support agent, hereinafter referred to as ‘human agent’, may interact with the user to help diagnose and resolve issues faced by the user and may ask the user to execute a series of instructions to aid in the diagnosis and resolution. As a human support agent can handle few call or text sessions concurrently, the efficiency of human support agents is generally low and the cost of providing such customer support services is high.

On the other hand, virtual support agents, such as chatbots, voice based virtual assistants, and the like, may be used to interact with multiple users concurrently. The virtual support agent, hereinafter referred to as ‘virtual agent’, may interpret inputs provided by the user and reply accordingly. Though the virtual agent may provide savings in terms of human resource costs, user satisfaction and rate of problem resolution during interaction with virtual agents is usually low.

Aspects of the present subject matter relate to providing human assisted virtual agent support to allow a virtual agent to handle multiple automated support chats and provide a notification to a human agent when human support is to be provided.

In an example, a conversation between a virtual agent and the user is initiated. For instance, the conversation may be in text form or in an audio form that gets transcribed to text. In an example, the user may send a message to enquire about products or services of interest, to resolve queries, to lodge complaints, and the like. A virtual agent instance may be instantiated to initiate communication with the user. The virtual agent may understand an issue from the message and may reply to the user with a resolution step. In an example, the resolution step may be selected by the virtual agent, using a first machine learning model, based on the issue identified. In one example, the first machine learning model may be trained based on a database of predefined resolution steps used to resolve issues.

After sending the resolution step, also referred to as ‘action’, to the user, the virtual agent may receive a response from the user indicating whether the action was successfully completed. In one example, the virtual agent may provide a set of responses from which a response may be selected by the user. In another example, the user may provide the response as a natural language text message. Based on the user response, a next action to be taken by the user may be provided by the virtual agent. In an example, the first machine learning model may be used to generate the next action to be provided to the user based on the response of the user. Thus, in an example, the first machine model may use action-response pairs to help resolve issues of users. In another example, the first machine model may use a feature vector generated from natural language processing as an input.

Further, the conversation, including the actions provided to the user and responses of the user, may be monitored to predict a probability of the user abandoning the conversation. In an example, a second machine learning model may be used to predict the probability of abandonment. The second machine learning model may be trained using unassisted conversations between virtual agents and users. If the predicted probability of the user abandoning the conversation is higher than a threshold, a notification may be sent to a human agent device to notify a human agent that manual support is to be provided to the user.

On receiving the notification, the human agent may intervene and provide the next action. The conversation between the human agent and the user may also be monitored to update the probability of abandonment. In one example, the virtual agent may take back the control of conversation for further communication based on, for example, a decrease in the probability of abandonment or an indication provided by the human agent that the virtual agent may handle the remaining conversation.

The virtual agent may maintain a context of the conversation, when it takes back the control from the human agent, based on the actions provided by the human agent in the conversation. In an example, the virtual agent treats the set of responses from the human agent as if they were provided by the virtual agent. The virtual agent may then use the set of responses to recommend the next action to the user. In an example, additional action-response pairs may be generated from the conversation held by the human agent and may be used to update the first machine learning model.

Thus, the present subject matter provides for better handling of user support issues by detecting the probability of a user abandoning the conversation and allowing a human agent to provide assistance if the probability increases to more than a threshold. Further, the present subject matter also enables one human agent to handle multiple concurrent user conversations. In one example, since action-response pairs and machine learning models may be used for resolution of user issues and prediction of probability of the user abandoning the conversation, complex Natural Language Processing (NLP) based models may not be used.

The following description refers to the accompanying drawings. Wherever possible, the same reference numbers are used in the drawings and the following description to refer to the same or similar parts. While several examples are described in the description, modifications, adaptations, and other implementations are possible. Accordingly, the following detailed description does not limit the disclosed examples. Instead, the proper scope of the disclosed examples may be defined by the appended claims.

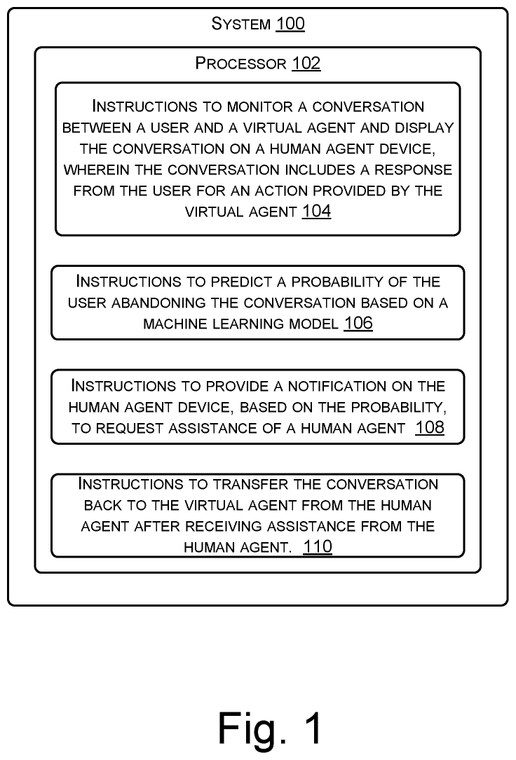

FIG. 1 illustrates a system 100 for providing human assisted virtual agent support, according to an example implementation of the present subject matter. The system 100 may be implemented as any of a variety of systems, such as a desktop computer, a laptop computer, a server, a tablet device, and the like.

The system 100 includes a processor 102. The processor 102 may be implemented as microprocessors, microcomputers, microcontrollers, digital signal processors, central processing units, state machines, logic circuitries, and/or any devices that manipulate signals based on operational instructions. Among other capabilities, the processor 102 may fetch and execute computer-readable instructions. The functions of the processor 102 may be provided through the use of dedicated hardware as well as hardware capable of executing machine readable instructions.

In addition to the processor 102, the system 100 may also include interface(s) and system data (not shown in FIG. 1). The interface(s) may include a variety of machine readable instructions-based interfaces and hardware interfaces that allow interaction with a user and with other communication and computing devices, such as network entities, web servers, networked computing devices, external repositories, and peripheral devices. The system data may serve as a repository for storing data that may be fetched, processed, received, or created by the processor 102.

In operation, the processor 102 may execute instructions 104 to monitor a conversation between a virtual agent and a user and to display the conversation on a human agent device. In an example, the conversation includes a response from the user for an action provided by the virtual agent.

In an example, the conversation may be initiated by the processor 102 by instantiating a virtual agent instance on receiving a message from the user for resolving an issue. The issue may be related to, for example, an enquiry about products/services of interest, a query about the working of a product, a complaint, and the like. The virtual agent may interpret the message to identify the issue based on words used in the message and suggest an action to be performed by the user based on a first machine learning model. The first machine learning model may be trained based on a database of predefined resolution steps used to resolve issues. The first machine learning model may additionally be based on action-response pairs that indicate the next action to be taken based on a response received from a user for the previously suggested action. For example, the action-response pair, such as restart printer—done, remove paper from tray—could not perform, etc., may be used to generate a next action to be suggested to the user. In an example, the system 100 that trains the first machine learning model may be the same as or different from the one that executes the first machine learning model.

In one example, after suggesting an action, the virtual agent may send a set of responses from which a response is to be selected by the user. The set of responses, such as done, not done, etc., may be indicative of success of performance of the action by the user. In another example, the user may provide a free text or natural language response to indicate whether the action was completed successfully, from which the virtual agent may identify words or phrases to understand the user's response. For example, feature vector generated from natural language processing of the free text may be used as the response. Further, the first machine learning model may be used to generate a next action to be suggested to the user based on the response.

In an example, the conversation between the virtual agent and the user may also be displayed on a human agent device monitored by a human agent. Hence, the human agent may be aware of the conversation as it takes place and may be able to intervene to provide assistance.

In one example, the conversation may also be monitored by the processor 102. Further, the processor 102 may execute instructions 106 to predict a probability of the user abandoning the conversation using a second machine learning model. In an example, the processor 102 may record parameters, such as user parameters, such as a user profile and demographics, such as age, gender, race, etc., of the user, and conversation parameters, such as time taken for providing resolution step, status of completion of conversation, abandonment of the conversation, complexity of the conversation etc., from previous conversations to train the second machine learning model. In an example, the system 100 that trains the second machine learning model may be the same as or different from the one that executes the second machine learning model. After training, the second machine learning model be utilized to predict the probability of abandonment of a conversation.

In an example, if the time taken by the user to perform an action is greater than an average time recorded, the probability of abandonment may be determined as high. In another example, if the user indicates in more than two successive responses that the actions were not successfully performed, the probability of abandonment may be determined as high. In another example, the probability may be determined in quantitative terms, for example as a percentage. In one example, the percentage probability of abandonment may be obtained as an output of a SoftMax or normalized exponential function from the second machine learning model. The SoftMax function helps in mapping a non-normalized output to a probability distribution over predicted output classes to obtain the probability in quantitative terms.

According to an example implementation of the present subject matter, the processor 102 may compare the probability of the user abandoning the conversation with a threshold. The threshold may be a quantitative threshold, such as 60%, or a qualitative threshold, such as ‘moderate’.

Further, if the probability of user abandoning the conversation is higher than the threshold, the processor 102 may execute instructions 108 to provide a notification on a human agent device to request assistance of a human agent. The human agent may then take over control of the conversation at the human agent device. The conversation between the human agent and the user may also be provided to the virtual agent for maintaining context by the virtual agent. In one example, the action-response pairs generated by the conversation between the human agent and user may also be used to update the first machine learning model.

In one example, the processor 102 may execute instructions 110 to transfer control of the conversation back to the virtual agent. In one example, if the probability decreases to below the threshold, the virtual agent may take back the control from the human agent and the conversation between the virtual agent and the user may be resumed. In another example, the human agent may provide an indication through the human agent device that the control is to be transferred back to the virtual agent so that the virtual agent may resume the conversation.

In an example, on resuming control, the virtual agent treats the set of actions provided from the human agent as if they were provided by the virtual agent. The virtual agent may then use the set of actions to recommend a next action to the user, thereby maintaining context in the conversation based on the assistance provided by the human agent. Thus, the transfer of control from the virtual agent to the human agent and back may be performed seamlessly.

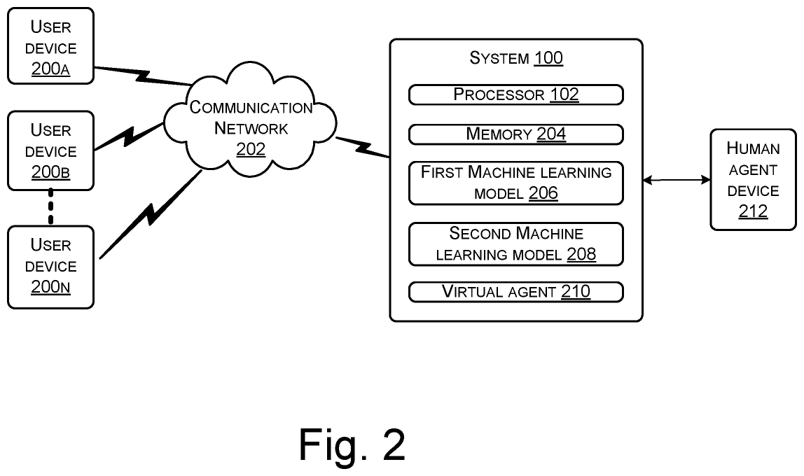

FIG. 2 illustrates a computing environment for human assisted virtual agent support, according to an example implementation of the present subject matter. In the computing environment, the system 100 may be connected to user devices 200a-n through a communication network 202. In one example, the computing environment may be a cloud environment. The system 100 may be implemented in the cloud to provide various services to the user devices 200a-n.

The user devices 200a-n, individually referred to as a user device 200 may be, for example, laptops, personal computers, tablets, multi-function printers, smart displays, and the like.

The communication network 202 may be a wireless or a wired network, or a combination thereof. The communication network 202 may be a collection of individual networks, interconnected with each other and functioning as a single large network (e.g., the internet or an intranet). Examples of such individual networks include Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN). Depending on the technology, the communication network includes various network entities, such as transceivers, gateways, and routers.

The system 100 may also include a memory 204 coupled to the processor 102. In an example, a first machine learning model 206, a second machine learning model 208, and other data, such as thresholds, action-response pairs, sets of responses, conversations, user parameters, conversation parameters, and the like may be stored in the memory 204 of the system 100. The memory 204 may include any non-transitory computer-readable medium including volatile memory (e.g., RAM), and/or non-volatile memory (e.g., EPROM, flash memory, Memristor, etc.). The memory 204 may also be an external memory unit, such as a flash drive, a compact disk drive, an external hard disk drive, a database, or the like.

The system 100 may receive a message from a user, through a user device 200. For ease of discussion, communication with the user device 200 is also referred to as communication with the user. The message received from the user may be related to a user issue, such as products/services of interest, queries, complaints, and the like. In an example, the system 100 may instantiate a virtual agent 210 to interpret the user message, identify the user issue, and have a conversation with the user to resolve the issue. In an example, the virtual agent 210 may be instantiated in the system 100. In another example, the virtual agent 210 may be instantiated in an external computing device connected to the system 100.

In operation, the virtual agent 210 may provide an action for performance by the user based on a first machine learning model. In an example, the action may include a troubleshooting step for the issue identified from the message received from the user. Further, the virtual agent 210 may receive a response from the user indicating the success of performance of the action. In one example, the user may select a response from a set of responses provided by the virtual agent 210. In another example, the user may provide a free text response or an open-ended voice response that gets transcript to text, which may be interpreted by the virtual agent 210. A next action to be taken by the user may be provided based on the response of the user using the first machine learning model 206.

In one example, conversations between virtual agents and users may be monitored to train a second machine learning model 208 to be able to predict probability of abandonment of a conversation. For example, conversation parameters, such as time taken for completing an action, status of completion of action, abandonment of the conversation, complexity of the issue, etc., may be recorded to train the second machine learning model 208. In an example, in addition to conversation parameters, user parameters such as a user profile and demographics, such as age, location, etc., of the user may also be used. In an example, the training of the second machine learning model may be performed by the same system as or a different system from the one that executes the second machine learning model. In an example, the second machine learning model may be based on, for example, support vector machines (SVMs), Random Forest, Boosted Decision Trees, Neural networks, or the like.

Subsequently, the system 100 may execute the second machine learning model while monitoring conversations between a user and a virtual agent 210 to predict the probability of the user abandoning the conversation. Accordingly, the system 100 may utilize the second machine learning model 208 to predict a probability of a user abandoning a conversation based on user parameters of the user and conversation parameters of the conversation. In an example, the processor 102 may compare the probability of user abandoning the conversation with a threshold. As discussed earlier, if the probability of user abandoning the conversation is higher than the threshold, a notification may be sent to a human agent device 212 to request assistance from a human agent.

The human agent device 212 may be for example, a laptop, a mobile device, a tablet, a desktop computer, or the like, and may be used by a human agent to assist the virtual agent 210 and thus increase the user satisfaction from the conversation. In an example implementation, the human agent device 212 may be in communication with the system 100, for example, over another network (not shown in the figure). The human agent device 212 may receive the notification from the system 100 for providing human assistance to the virtual agent 210. For example, the notification may be a flag, an icon displayed on a user interface, a sound alert, a text message, etc., to ask the human agent to intervene and provide assistance in the conversation. For ease of discussion, communication with the human agent device 212 is also referred to as communication with the human agent.

In an example, while the system 100 monitors the conversation between the virtual agent 210 and the user, the conversation is also mirrored on the human agent device 212. Thus, the human agent may be made aware of the actions suggested by the virtual agent 210 and the user's responses. In some cases, the human agent may choose to intervene and provide support without receiving the notification from the system 100, for example, if the human agent is of the opinion that a different action than that suggested by the virtual agent 210 may help in resolving the user issue.

On receiving an indication from the human agent that the human agent would like to provide assistance, based on the notification or on their own accord, the control of the conversation may be transferred to the human agent device 212. In one example, the indication may be provided by the human agent by typing text into a chat window of the conversation. In another example, the indication may be provided by the human agent by selecting, for example, clicking on, a button provided on the user interface of the human agent device 212.

To transfer control to the human agent device 212, and thereby to the human agent, the system 100 may send a message to the virtual agent 210 to stop providing actions to the user. Further, the actions provided by the human agent may be displayed on the same user interface of the user device 200 in which the actions provided by the virtual agent 210 were displayed. Thus, the transfer of control may be seamless and transparent from the user's perspective.

In one example, the conversation between the human agent and the user may be mirrored to the virtual agent 210 so that the virtual agent 210 is aware of the context of the conversation between the human agent and the user. In an example, after the human agent takes control of the conversation, the conversation between the human agent and the user may also be monitored and may be used to further determine the probability of abandonment. For example, after the human agent provides an action to the user, the human agent may ask the user to provide a response indicating the success of performance of the action. Thus, user and conversation parameters, similar to those gathered for a conversation between the virtual agent 210 and the user, may be gathered and the probability of abandonment may be determined again.

In one example, control of the conversation may be automatically transferred back to the virtual agent 210 if the probability falls below the threshold. In another example, the control of the conversation may be transferred back to the virtual agent 210 if the human agent indicates that the virtual agent 210 may take back the control, for example, by clicking on a button or not providing a next action within a particular time frame after receiving response from the user, and the like.

To transfer control back to virtual agent, the system 100 may send a message to the virtual agent 210 to start providing actions to the user. On resuming control, the virtual agent 210 may treat the set of actions provided from the human agent as if they were provided by the virtual agent 210. The virtual agent 210 may then use the set of actions and the last response provided by the user to recommend a next action to the user, thereby maintaining context in the conversation. Thus, the transfer of control back to the virtual agent 210 may be performed seamlessly so that the user may not be aware that such transfer of control has happened. This can help in increasing user satisfaction with the support process.

In one example, the first machine learning model 206 may be updated based on the conversation history between the human agent device 212 and the user device 200. Further, when the conversation ends, either due to abandonment by the user or successful resolution of the issue, the user parameters and the conversation parameters may be used to update the second machine learning model 208. Thus, the machine learning models may be updated to handle new issues and conversations.

For example, considering a scenario where a user provides the following message as an issue “Cannot connect to printer from the device”. Based on the input, the system may call a virtual assistant instance to assign a virtual agent 210 that may interpret the issue from the user message and may automatically start the conversation and provide the user with a resolution step. In an example, the virtual agent 210 identifies the issue as “printer connection problem” and may provide the resolution step as “check if printer cable is connected to the device”. Further, the virtual agent may ask the user to provide a response indicating if the resolution step was completed. For example, the virtual agent may provide a set of responses from which a response is to be selected by the user. In an example, the virtual agent may provide a set of responses such as “done”, “didn't work”, etc. In another example, the user may provide the response as a free text input. Based on the response, the next resolution step may be provided by the virtual agent. In an example, the first machine learning model 206 may be used to generate the actions or resolution steps to be suggested to the user.

If the user replies with “didn't work”, for example, from the set of responses, the virtual agent 210 may generate a next step to be shown to the user such as “restart the laptop and check for the printer connection” followed by a set of responses such as “OK”, “Later”, etc.

The system 100 may utilize the second machine learning model 208 for predicting, based on the response received from the user, the probability of the user abandoning the conversation. In an example, if the user selects the response “Later”, the second machine learning model 208 may predict that the user may not be satisfied with the action suggested by the virtual agent 210, and therefore may notify the human agent to intervene.

In an example, the system 100 may transfer control to the human agent device 212 to intervene in the conversation, and the human agent may provide a resolution step such as “please check for printer driver in device manager”. The human agent may also ask the user to indicate if the action was completed. In an example, the user may provide “done” as a response. Thereafter, the human agent may provide a next action or may transfer the control back to the virtual agent 210.

In an example, the actions suggested by the human agent may be used to create additional action-response pairs. For example, the action-response pairs used by the human agent, such as “please check for printer driver in device manager”—“done”, may be used to update the first machine learning model 206, for use by the virtual agent 210 in future conversations.

On transfer of control back to the virtual agent 210, the virtual agent 210 may resume the conversation while noting the context by providing further resolution steps based on the actions suggested by the human agent, such as “update the printer driver software, if it is outdated”, or by ending the conversation if no further action is to be provided. Thus, the human agent resources may be used efficiently, the effectiveness of the virtual agent may also be increased, and high user satisfaction with the support provided may be achieved.

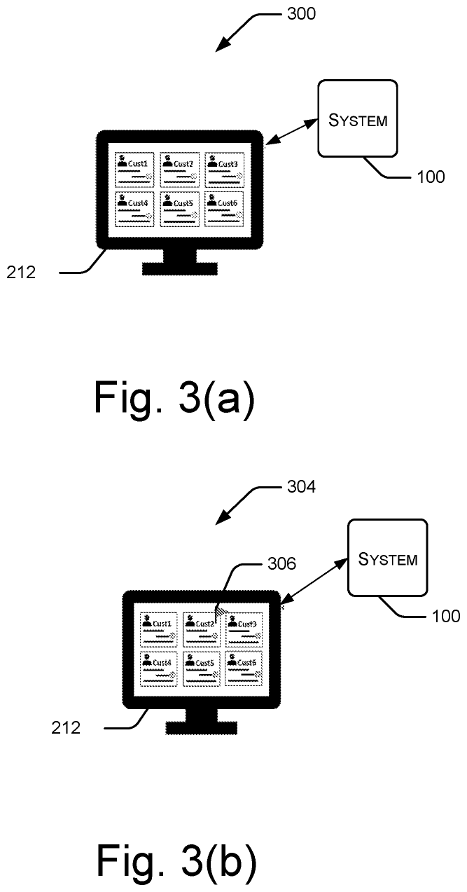

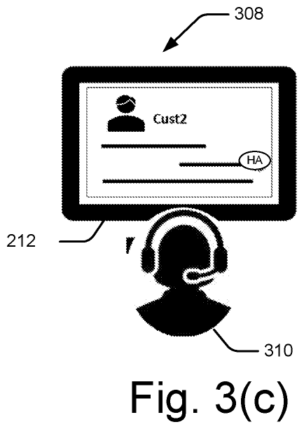

FIGS. 3(a)- 3(c) illustrate example scenarios for human assisted virtual agent support, according to an example implementation of the present subject matter. FIG. 3(a) shows an example scenario 300 where the human agent device 212 is in communication with the system 100. As explained earlier, the system 100 may initiate and monitor conversations between virtual agents 210 and user devices 200.

Consider a scenario where multiple users may call the customer support centre concurrently. In such a scenario, the system 100 may call multiple virtual assistant instances to instantiate multiple virtual agents to converse with the users. A virtual agent may understand an issue of a user from the user's input and may automatically respond to the user with resolution steps.

As shown in FIG. 3(a), the human agent device 212 may display a conversation window on the display interface of the human agent device 212 for a user-virtual agent conversation. The user-virtual agent conversation may be mirrored to the human agent device 212 so that the human agent is aware of the conversation. In one example, to handle multiple conversations concurrently, multiple conversation windows may be displayed on the human agent device 212, as shown in the scenario 300.

Based on monitoring the conversations and a machine learning model 208, the system 100 may determine the probability of the users abandoning respective conversations. If, for a conversation, the system 100 predicts that the probability of the user abandoning the conversation is higher than a threshold, the system 100 may send a notification 306 to the human agent device 212 as shown in an example scenario 304 in FIG. 3(b).

In an example, the notification may be a flag or other icon displayed on the conversation window of that conversation for which the probability of abandonment is higher than the threshold. In various examples, the notification may be provided by, for example, changing the color of conversation windows, providing a sound alert, causing the conversation window to flicker, and the like.

On receiving the notification, the human agent 310 may provide assistance in the conversation to the user, as shown in an example scenario 308 in FIG. 3(c). For example, the human agent 310 may provide next actions to be taken by the user.

Subsequently, the conversation between the virtual agent 210 and the user may be resumed. In an example, the actions suggested by the human agent 310 are also provided to the virtual agent 210 to maintain the context of the conversation on resumption. Therefore, when the conversation is resumed between the virtual agent 210 and the user, the actions suggested by the human agent 310 are available with the virtual agent 210 to proceed with the conversation in the same context.

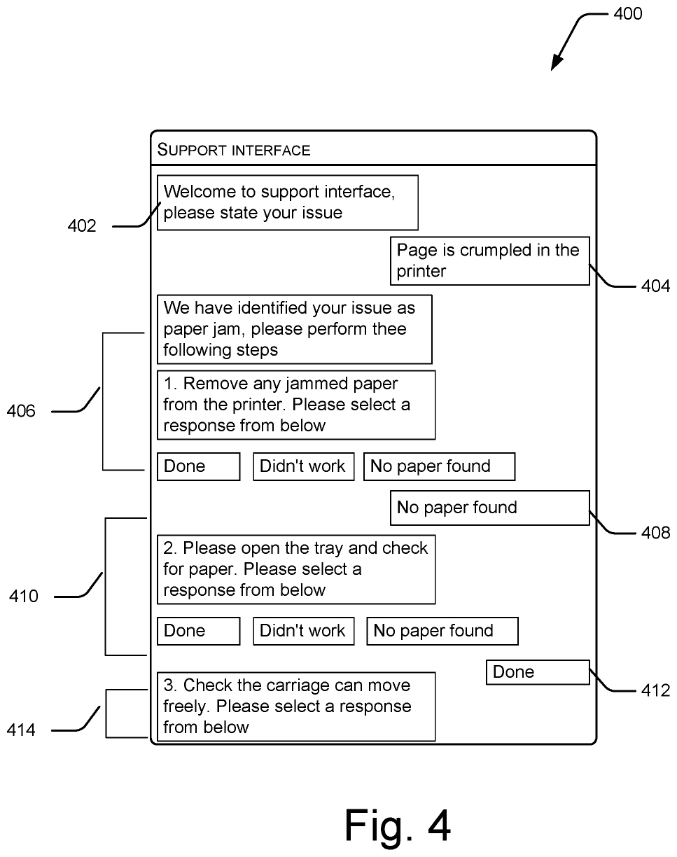

FIG. 4 illustrates an example user interface depicting human assisted virtual agent support, according to an example implementation of the present subject matter. In an example, the support interface 400 is provided on a display of the user device 200. The user device 200 may display the support interface 400 for receiving support for an issue. In an example, the system 100 may display a welcome text on the support interface 400 as shown in message block 402. Further, the user may input the issue as shown in the message block 404. In an example, the user indicates that they are facing an issue related to crumpling of paper in a printer.

The system 100 may call a virtual agent instance to assign a virtual agent 210 to initiate a conversation with the user. In an example, the virtual agent may interpret the issue from the user input. In an example, the virtual agent 210 may identify the issue as paper jam as shown in message blocks 406. Further, the virtual agent 210 may automatically respond to the user with a resolution step. In an example, the resolution step in message blocks 406 includes suggesting that the user remove any jammed paper from the printer. In one example, the resolution step or action may be determined using the first machine learning model 206.

In one example, the virtual agent 210 may also send a set of responses from which a response is to be selected by the user as shown in message blocks 406. In an example, the set of responses are possible responses to the indicate performance of the resolution step.

The user may select a response from the set of responses as shown in message block 408. The system 100 may monitor the conversation to predict a probability of the user abandoning the conversation. In an example, the system 100 may record conversation parameters, such as time taken for providing resolution step, status of completion of conversation, abandonment of the conversation, complexity of the conversation, etc., and may utilize the second machine learning model 208 to identify a probability of user abandoning the conversation. In an example, the system 100 may also use user parameters such as a user profile, demographics, such as age, gender, race etc., of the user to predict the probability of abandonment.

In an example, if the probability of user abandoning the conversation is higher than a threshold, a notification is sent to a human agent 310. For example, if the user replies with ‘No paper found’ at message block 408, a human agent 310 may be notified.

Upon receiving the notification, the human agent 310 may provide assistance by providing a next resolution step as shown in message blocks 410. For example, the human agent 310 may ask the user to open the tray and check for paper. In an example, the human agent 310 may also cause a set of responses from which a response is to be selected by the user to be displayed, as shown in message blocks 410.

In an example, the user may select a response from the set of responses as shown in message block 412. Based on the response, the probability of abandonment may be again determined. Further, the control may be passed back to the virtual agent 210, for example, if the probability of the user abandoning the conversation reduces to less than the threshold or based on an indication provided by the human agent 310.

For example, at message block 414, the virtual agent 210 may take control and provide the next action asking the user to check if the carriage can move freely. In an example, to provide the next action, the virtual agent treats the set of actions from the human agent as if they were provided by the virtual agent to determine the context of the conversation. The virtual agent may then use the set of actions suggested by the human agent and the latest response provided by the user to recommend the next action to the user based on the first machine learning model 206. Thus, the virtual agent 210 may maintain a context in the conversation with the user when providing the next action by taking into account the previous actions suggested by the human agent 310.

Further, though in the support interface 400, the control passes from the virtual agent 210 to the human agent 310 and back to the virtual agent 210, the transfer of control may be seamless and may not be identifiable by the user.

While the example support interface 400 illustrates an example scenario where a set of responses are provided to the user from which the user may select a response, it will be understood that in other examples, the user may provide the response as a natural language or free text message, which may be processed to interpret the user's response.

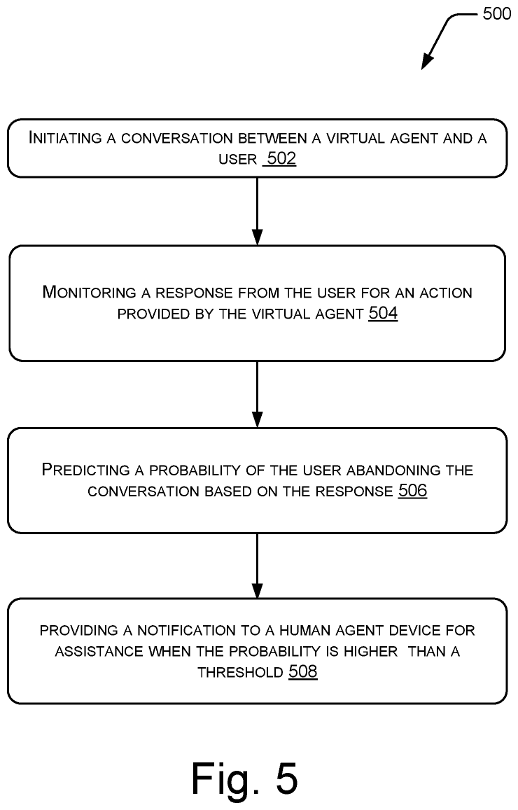

FIG. 5 illustrates a method of providing human assisted virtual agent support, according to an example implementation of the present subject matter.

The order in which the method 500 is described is not intended to be construed as a limitation, and some of the described method blocks can be combined in a different order to implement the methods or alternative methods. Furthermore, the method 500 may be implemented in any suitable hardware, computer-readable instructions, or combination thereof. The blocks of the method 500 may be performed by either a system under the instruction of machine-executable instructions stored on a non-transitory computer-readable medium or by dedicated hardware circuits, microcontrollers, or logic circuits. Herein, some examples are also intended to cover non-transitory computer-readable medium, for example, digital data storage media, which are computer-readable and encode computer-executable instructions, where the instructions perform some or all of the blocks of the method 500. While the method 500 may be implemented in any device, the following description is provided in the context of system 100 as described earlier with reference to FIGS. 1-4 for ease of discussion.

Referring to method 500, at block 502, a conversation is initiated by a system between a virtual agent and a user. The virtual agent may be for example, the virtual agent 210, and the system may be, for example, the system 100. The virtual agent 210 may receive a message from a user of a user device 200 and may provide a resolution step or action to be performed for an issue. Further, the virtual agent 210 may receive a response from the user indicating whether the resolution step has been performed.

At block 504, the conversation, for example, the suggested action and a response from the user, may be monitored by the system 100.

In an example, the system 100 may utilize a second machine learning model 208 to predict a probability of the user abandoning the conversation as shown in block 506. In an example, the system 100 may use user parameters and conversation parameters for predicting the probability of the user abandoning the conversation based on the machine learning model. The machine learning model, such as the second machine learning model 208 may be trained using the conversation parameters and the user parameters. In one example, the user parameters may be selected from: a user profile and demographics and, the conversation parameters may be selected from time taken for providing resolution step, status of completion of conversation, abandonment of the conversation and complexity of a user issue.

In an example, if the probability of the user abandoning the conversation is higher than a threshold, a notification may be sent to a human agent to provide assistance in the conversation as shown in block 508. For example, the notification may be a flag or other icon displayed on a conversation window shown on a human agent device used by the human agent to monitor the conversation.

In one example, when the human agent provides assistance, if the probability decreases to less than the threshold or based on an indication provided by the human agent, the conversation may be resumed between the virtual agent 210 and the user while maintaining context of the conversation. In an example, the virtual agent treats the set of actions from the human agent as if they were provided by the virtual agent. The virtual agent may then use the set of actions to recommend next action to the user in the same context.

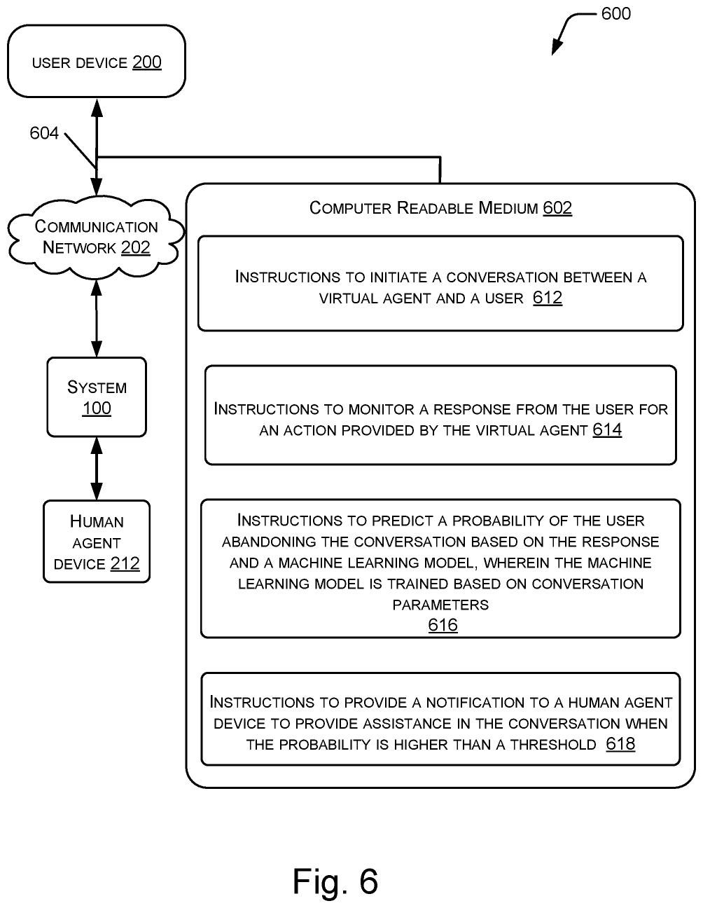

FIG. 6 illustrates a computing environment, implementing a non-transitory computer-readable medium for by human assisted virtual agent support, according to an example implementation of the present subject matter.

In an example, the non-transitory computer-readable medium 602 may be utilized by a system, such as the system 100. The computing environment 600 includes a user device, such as the user device 200, and the system 100 communicatively coupled to the non-transitory computer-readable medium 602 through a communication link 604. The non-transitory computer-readable medium 602 may be, for example, an internal memory device or an external memory device. In some examples, the non-transitory computer-readable medium 602 may be a part of the memory 204.

In an example implementation, the computer-readable medium 602 includes a set of computer-readable instructions, which can be accessed by the processor 102 of the system 100 and subsequently executed to handle user support issues by human assisted virtual agent support.

In one implementation, the communication link 604 may be a direct communication link, such as any memory read/write interface. In another implementation, the communication link 604 may be an indirect communication link, such as a network interface. In such a case, the user device 200 may access the non-transitory computer-readable medium 602 through a communication network 202. The communication network 202 may be a single network or a combination of multiple networks and may use a variety of different communication protocols.

Referring to FIG. 6, in an example, the non-transitory computer-readable medium 602 includes instructions 612 that cause the processor 102 of the system 100 to initiate a conversation between the virtual agent 210 and the user of the user device 200. In an example, the user may provide an input to enquire about products/services of interest, to resolve queries, to lodge complaints, and the like.

In an example, the virtual agent 210 may interpret the input to identify an issue and may automatically respond to the user with a resolution step. In an example, the resolution step may include a troubleshooting step for the user's issue that is identified from the users input.

The non-transitory computer-readable medium 602 includes instructions 614 that cause the processor 102 of the system 100 to monitor a response from the user for an action provided by the virtual agent 210. In an example, the user may select a response from a set of responses provided by the virtual agent. In another example, the user may provide the response in free text form.

The non-transitory computer-readable medium 602 includes instructions 616 that cause the processor 102 of the system 100 to predict a probability of the user abandoning the conversation based on the response and a machine learning model, such as the second machine learning model 208. In an example, the machine learning model 208 may be trained based on conversation parameters, such as time taken for providing resolution step, successful completion of conversation, abandonment of the conversation, complexity of the conversation etc. In an example, the second machine learning model may also take into account user parameters, such as a user profile, demographics such as age, gender, race etc., of the user to predict the probability of abandonment.

The non-transitory computer-readable medium 602 includes instructions 618 that cause the processor 102 of the system 100 to provide a notification to a human agent device 212 to provide assistance in the conversation when the probability is higher than a threshold.

In an example, the conversation between the virtual agent 210 and the user may be resumed, for example, based on an indication from the human agent or if the probability of abandonment reduces to below the threshold when the human agent provide assistance.

The present subject matter thus provides for better handling of user support issues by detecting the probability of the user abandoning the conversation and allowing a human agent to provide assistance. Further, the present subject matter also enables a human agent to handle multiple concurrent user conversations. Since action-response pairs may be used for resolution of user issues and prediction of probability of the user abandoning the conversation in some examples, complex Natural Language Processing (NLP) based models may not be used.

The present subject matter also reduces the human agent interaction time as the human agents provide assistance when the probability of user abandoning the conversation is higher than the threshold, thereby increasing the efficiency of the human agent.

The preceding description has been presented to illustrate and describe examples of the principles described. This description is not intended to be exhaustive. Many modifications and variations are possible in light of the above teaching.

1. A method comprising:
initiating a conversation between a virtual agent and a user;
monitoring a response from the user for an action provided by the virtual agent;
predicting a probability of the user abandoning the conversation based on the response; and
providing a notification to a human agent to provide assistance when the probability is higher than a threshold.

2. The method of claim 1, wherein the response is from a set of responses provided to the user.

3. The method of claim 1, wherein the response is indicative of success of performance of the action by the user.

4. The method of claim 1 comprising recording user parameters and conversation parameters for training a machine learning model, wherein the user parameters are selected from: a user profile and demographics and, the conversation parameters are selected from time taken for providing resolution step, status of completion of conversation, abandonment of the conversation and complexity of a user issue.

5. The method of claim 4 comprising predicting the probability of the user abandoning the conversation based on the machine learning model.

6. The method of claim 1 comprising allowing the virtual agent to resume the conversation when the probability of the user abandoning the conversation decreases to less than the threshold.

7. The method of claim 6 comprising maintaining a context in the conversation when the virtual agent resumes the conversation.

8. The method of claim 1, wherein the notification provided to the human agent is shown in a conversation window on a human agent device.

9. A system comprising:
a processor to:
monitor a conversation between a user and a virtual agent and display the conversation on a human agent device, wherein the conversation includes a response from the user for an action provided by the virtual agent;
predict a probability of the user abandoning the conversation based on a machine learning model;
provide a notification on the human agent device, based on the probability, to request assistance of a human agent; and
transfer control of the conversation back to the virtual agent from the human agent after receiving assistance from the human agent.

10. The system of claim 9, wherein the response is selected from a set of responses indicating a success of completion of an action for resolution of a user issue.

11. The system of claim 9, wherein the notification is provided on the human agent device when the probability of the user abandoning the conversation is higher than a threshold.

12. The system of claim 9, wherein the virtual agent is to maintain a context in the conversation based on the assistance provided by the human agent when the control is transferred back to the virtual agent.

13. A non-transitory computer-readable medium comprising instructions for human assisted virtual agent support, the instructions being executable by a processor to:
initiate a conversation between a virtual agent and a user;
monitor a response from the user for an action provided by the virtual agent;
predict a probability of the user abandoning the conversation based on the response and a machine learning model, wherein the machine learning model is trained based on conversation parameters; and
provide a notification to a human agent device to provide assistance in the conversation when the probability is higher than a threshold.

14. The non-transitory computer-readable medium of claim 13, wherein the conversation parameters are selected from time taken for providing resolution step, successful completion of conversation, abandonment of the conversation and complexity of a user issue.

15. The non-transitory computer-readable medium of claim 13, wherein the instructions are executable by the processor to transfer control of the conversation back to the virtual agent to resume the conversation between the virtual agent and the user, and to maintain a context in the conversation when the conversation is resumed.
